(19) United States
(12) Patent Application Publication
(10) Pub. No.: US 2003/0075498 A1
(43) Pub. Date: Apr. 24, 2003

(54) Hemodialyzer headers

(76) Inventors: Randolph H. Watkins, Wonder Lake, IL (US); Michael Prisco, Geneva, IL (US); James S. Slepicka, Spring Grove, IL (US)

Correspondence Address: BAXTER HEALTHCARE CORPORATION, RENAL DIVISION, 1 BAXTER PARKWAY, DF3-3E, DEERFIELD, IL, 60015, US

(21) Appl. No.: 09/871,863

(22) Filed: Jun. 1, 2001

(51) Int. Cl. B01D 65/00; B01D 61/28

(52) U.S. Cl. 210/456; 210/321.6; 210/321.71

(57) ABSTRACT

Dialyzers having an improved header design providing an improved flow of fluid, e.g., blood, into the interior of the dialyzer and specifically to the fiber bundle are provided. The dialyzer inlet header comprising a body that defines, at least in part, an end of the dialyzer. The inlet header includes an inlet channel providing fluid communication from an exterior of the dialyzer to an interior of the dialyzer, the inlet channel defining a fluid flow path that is axial to a fiber bundle located in the interior of the dialyzer. The dialyzer also includes at least one member for modifying the fluid flow path of a fluid as it exits the inlet channel. Methods of providing dialysis are also provided.

### BACKGROUND OF THE INVENTION

The present invention relates generally to methods of providing therapies. More specifically, the present invention relates to methods and devices for providing dialysis.

Due to diseases, insult or other causes, the renal system can fail. In renal failure of any cause, there are several physiological derangements. The balance of water, minerals (Na, K, Cl, Ca, P, Mg, SO₄) and the excretion of daily metabolic load of fixed hydrogen ions is no longer possible in renal failure. During renal failure, toxic end products of nitrogen metabolism (urea, creatinine, uric acid, and others) can accumulate in blood and tissues.

Dialysis processes have been devised for the separation of elements in a solution by diffusion across a semi-permeable membrane (diffusive solute transport) down a concentration gradient. Principally, dialysis comprises two methods: hemodialysis; and peritoneal dialysis.

Hemodialysis treatment utilizes the patient's blood to remove waste, toxins, and excess water from the patient. The patient is connected to a hemodialysis machine and the patient's blood is pumped through the machine. Catheters are inserted into the patient's veins and arteries to connect the blood flow to and from the hemodialysis machine. Waste, toxins, and excess water are removed from the patient's blood and the blood is infused back into the patient. Hemodialysis treatments last several hours and are generally performed in a treatment center about three to four times per week.

Hemodialysis typically involves the use of a dialyzer. Dialyzers generally comprise a housing or casing. Located within the interior of the casing is a fiber bundle. Typically the fiber bundle is comprised of a number of membranes that are oriented parallel to each other. The membranes are designed to allow blood to flow therethrough with dialysate flowing on the outside of the membranes. Due to an osmotic gradient that is created, waste products are removed from the blood through the membranes into the dialysate.

Accordingly, dialyzers typically include a blood inlet and a blood outlet. The blood inlet is designed to cause blood to enter the fiber membranes and flow therethrough. Dialysate is designed to flow through an inlet of the dialyzer and out of the dialyzer through an outlet. The dialysate is designed to flow across the outside or exterior walls of the membranes.

One of the issues with prior dialyzers is that the flow of the blood through the fiber bundles may not be entirely satisfactory. In this regard, blood may not flow sufficiently through the entire fiber bundle. Rather, there often occurs clotting in areas of low or no flow. For a cylindrical dialyzer, these areas are usually found along the outer perimeter of the surface in which the fibers are embedded.

Accordingly, there is a need for improved dialyzers that eliminate or reduce the zones of low flow.

### SUMMARY OF THE INVENTION

The present invention relates generally to dialyzers for use in dialysis therapies. More specifically, the present invention relates to dialyzers having an improved header design providing an improved flow of blood into the interior of the dialyzer and specifically to the fiber bundle. This eliminates, or at least substantially reduces, the zones of low flow thereby reducing the potential for clotting while improving the ability to rinse the header of blood.

To this end, the present invention provides a dialyzer inlet header comprising a body that defines, at least in part, an end of the dialyzer. The inlet header includes an inlet channel providing fluid communication from an exterior of the dialyzer to an interior of the dialyzer, the inlet channel defining a fluid flow path that is axial to a fiber bundle located in the interior of the dialyzer. The dialyzer also includes at least one member for modifying the fluid flow path of a fluid as it exits the inlet channel.

In an embodiment, the member for modifying the fluid flow path is a curved vane extending from a portion of the body of the inlet header. In a further embodiment, the dialyzer inlet header includes eight vanes.

In an embodiment, the inlet channel is located at a center of the inlet header body.

In an embodiment, the inlet header is sealed to an end of a dialyzer casing.

In an embodiment, the member for modifying the fluid flow path is a curved channel extending into a portion of the inlet header body.

In an embodiment, the dialyzer inlet header includes eight channels extending into the body.

In an embodiment, the member obstructs the flow of fluid as it exits the inlet fluid channel.

In an embodiment, the member is a disk located under an exit opening of the inlet fluid channel. In a further embodiment, the inlet header body includes a plurality of curved vanes. In a still further embodiment, the body includes a plurality of curved channels.

In another embodiment of the present invention, a dialyzer is provided comprising a body defining an interior and having a first end and a second end, and a fiber bundle located in the interior. A blood inlet is located at the first end of the dialyzer and includes a fluid flow channel that causes the blood to flow in an axial direction with respect to the fiber bundle. A member is located in juxtaposition to the blood inlet that causes blood to flow to a perimeter region of a first end of the fiber bundle as it enters the dialyzer.

In an embodiment, the member for modifying the fluid flow path is a curved vane extending from a portion of the inlet header body.

In an embodiment, the member for modifying the fluid flow path is a curved channel extending into a portion of the inlet header body.

In an embodiment, the member for modifying is a disk located under an exit opening of the inlet fluid channel.

In yet a further embodiment of the present invention, a dialyzer header is provided comprising a body member having an inlet channel providing fluid communication from an exterior to an interior of the header. The inlet channel defining a fluid path that is axial to a body of a dialyzer to which the dialyzer head is attached and the body member including a plurality of members that impart a circular motion to the fluid as it enters the interior of the header.

In an embodiment, the members are a plurality of curved vanes.

In an embodiment, the members are a plurality of curved channels.

In an embodiment, a member that obstructs the flow of fluid from the inlet channel as it enters the interior of the header is provided. In a further embodiment, the member that obstructs is a disk located under the inlet channel.

Furthermore, in an embodiment, the present invention provides a method for providing dialysis. The method comprises the steps of passing blood through a dialyzer that includes a blood inlet that defines an axial flow path to a fiber bundle located in the dialyzer and modifying the flow path as the blood enters the dialyzer to increase the flow of blood to a perimeter of an end of the fiber bundle.

In an embodiment of the method, the flow path is modified by passing at least some of the blood through channels.

In an embodiment of the method, the flow path is modified by passing at least some of the blood through vanes.

In an embodiment of the method, the flow path is modified by preventing the flow of the blood directly from the inlet to the fiber bundle.

An advantage of the present invention is to provide an improved dialyzer.

Moreover, an advantage of the present invention is to provide an improved header design for a dialyzer.

Still further, an advantage of the present invention is to provide an improved method for providing dialysis.

An additional advantage of the present invention is to provide improved distribution of blood to a fiber bundle in a dialyzer.

Still, an advantage of the present invention is to reduce or eliminate stagnant zones.

Furthermore, an advantage of the present invention is to improve blood flow through a dialyzer.

Additionally, an advantage of the present invention is to provide a dialyzer having improved ability to rinse the header of blood.

Additional features and advantages of the present invention will be described in and apparent from the detailed description of the presently preferred embodiments and the figures.

### BRIEF DESCRIPTION OF THE FIGURES

FIG. 1 illustrates a perspective view of an embodiment of a dialyzer.

FIG. 2 illustrates a bottom view of an embodiment of a dialyzer header of the present invention.

FIG. 3 illustrates a bottom view of another embodiment of a dialyzer header of the present invention.

FIG. 4 illustrates a bottom view of a still further embodiment of a dialyzer header of the present invention.

### DETAILED DESCRIPTION OF THE INVENTION

The present invention provides improved dialyzers and methods for providing dialysis to a patient. Although in an embodiment set forth in detail below the present invention is designed for use in hemodialysis, the present invention can be used in other and non-traditional therapies. Such methods include, for example, continuous flow or regeneration therapies which may or may not include hemodialysis, for example, continuous flow peritoneal dialysis. Further, although the present invention is designed, in an embodiment, to be utilized for hemodialysis in patients having chronic kidney disease or failure and therefore require regular treatments, the present invention can be utilized for acute dialysis therapy, for example, in an emergency room setting.

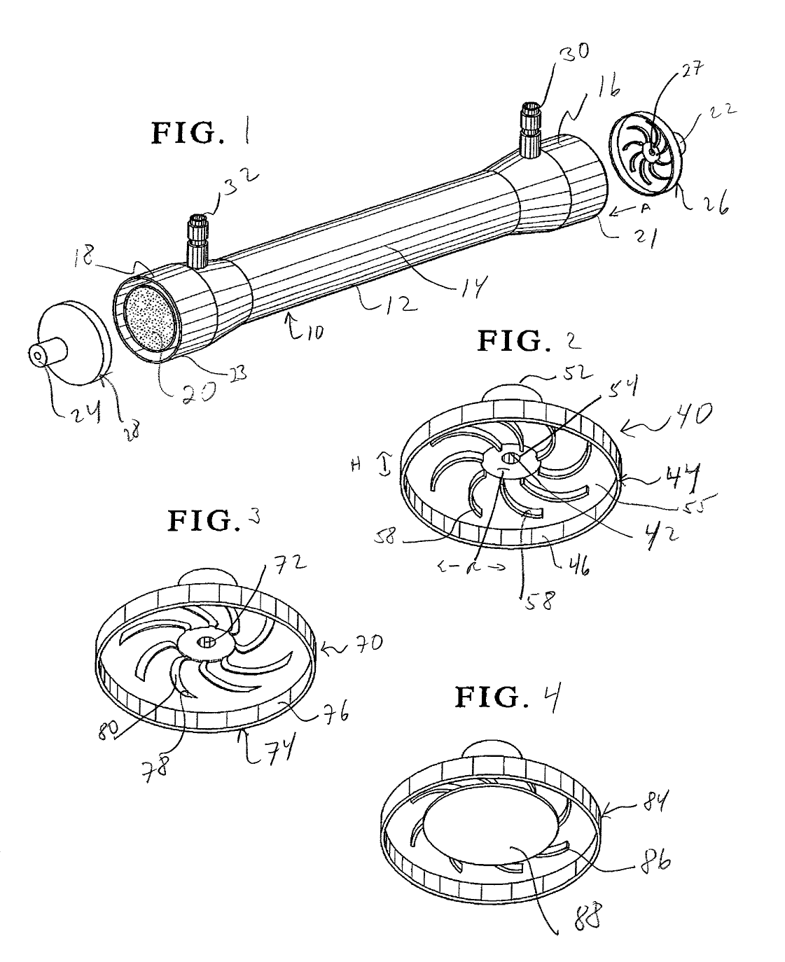

Referring now to FIG. 1, a dialyzer 10 is generally illustrated. The dialyzer 10 includes a body member 12 that generally comprises a casing. The casing includes a core 14 section as well as two bell members 16 and 18 located at each end of the dialyzer 10. Located within the core or casing is a fiber bundle 20.

The fiber bundle 20 includes a plurality of fiber membranes. The fiber membranes are semipermeable having a selective permeability. The fiber membranes are bundled together and assembled in the casing in a manner allowing blood to flow simultaneously in a parallel manner through the lumina of the fibers while a blood-cleansing liquid (dialysate) is simultaneously passed through the casing so as to bathe the exterior surfaces of the hollow fibers with the liquid. A variety of compounds can be used to produce selectively permeable membranes including polymers such as: cellulose; cellulose acetate; polyamide; polyacrylonitarile; polyvinylalcohol; polymethyl methacrylate; polysulfone; and polyolefin. The fiber bundle is encapsulated (potted) at each end of the dialyzer to prevent blood from flowing around the fibers.

Located at a first end 21 of the dialyzer 10 is a fluid inlet 22 and at a second end 23 a fluid outlet 24. The fluid inlet 22 and fluid outlet 24 are defined by a fluid inlet header 26 and a fluid outlet header 28, respectively. Generally, the fluid inlet header 26 is designed to allow blood, or other fluid, to flow into an interior of the dialyzer 10 through the fiber bundle 20. The fluid outlet 24 is designed to allow the dialyzed blood, or other fluid, to flow out of the dialyzer 10. As illustrated, blood flows into the dialyzer in an axial direction “A.” As used herein, axial means that the blood flow into the dialyzer 10, and specifically the inlet channel 27 of the inlet header 26, is in the same direction as the flow of blood through the fiber bundles 20.

In the preferred embodiment illustrated, the dialyzer body 10 includes a dialysate inlet 30 and a dialysate outlet 32. In the embodiment illustrated, the dialysate inlet 30 and dialysate outlet 32 define fluid flow channels that are in a radial direction, i.e., perpendicular to the fluid flow path of the blood through the fiber bundle 20. The dialysate inlet 30 and dialysate outlet 32 are designed to allow dialysate to flow into the interior of the dialyzer 10 bathing the exterior surface of the fibers in the fiber bundle 20 and then out through the outlet 32. As is known in the art, this causes waste and other toxins to be removed from the blood through the semipermeable membrane of the fibers and carried away by the dialysate.

If desired, the dialyzer 10 can be one integral piece. In this regard, the inlet header 26 and outlet header 28 can be integrally molded to the remaining portions of the dialyzer body 12. However, in a preferred embodiment, the dialyzer headers 26 and 28 are sealed to the first and second end of the dialyzer body 10. This allows the fiber bundles to be inserted into the dialyzer and potted as is known in the art.

It should be noted that a variety of dialyzer bodies can be utilized. In a preferred embodiment, the header designs of the present invention are utilized with a dialyzer housing that is modified to provide improved perfusion of the dialysate to the fiber bundle. In this regard, reference is made to U.S. patent application Ser. No. ______, entitled “Hemodialyzer Having Improved Dialysate Perfusion” which is being filed herewith, the disclosure of which is hereby incorporated herein by reference.

Generally, the inlet header 30 design of the present invention increases blood flow in the perimeter region of the fiber bundle 20. As used herein, this means to cause more blood to flow to the perimeter of the fiber bundle than in prior art dialyzer designs that included a standard header design, i.e., a header that does not include any members that modified the flow of the blood as it entered an interior of the dialyzer. The header designs of the present invention reduce the low blood flow zones within the dialyzer header. In this regard, the header designs of the present invention increase blood flow in the perimeter region of the header space where low flows are suspected thus reducing the potential for clot formation. Additionally, these improved flow patterns provide a more complete clearing of blood during rinse back.

Referring now to FIG. 2, an embodiment of a header design 40 is illustrated. The header 40 includes an inlet channel 42. In a preferred embodiment, the inlet channel 42 is located in a center of the body 44 of the inlet header 40. The inlet channel 42 defines a fluid flow path that is axial, i.e., in the same direction as the fluid flow of the blood through the fiber bundle 20.

The body 44 also includes a lip member 46 that circumscribes and defines an opening for receiving an end 21 of the dialyzer 10. This allows the header 40 to be sealed on an inlet end 21 of the dialyzer 10.

The inlet channel 42 includes an inlet opening 52 and an outlet opening 54. The inlet opening 52 is placed in fluid communication with a member carrying blood, e.g., a tube. This allows blood to flow from a source, e.g., catheter in a patient, into the inlet opening 52 and out through the outlet opening 54 into an interior of the dialyzer 10.

The body 44 includes, on a top interior surface 55 thereof, a plurality of members that are designed to modify the fluid flow characteristics of blood as it enters an interior of the inlet header 40. In the embodiment illustrated, these members are a number of vanes 58. The vanes 58 extend from a top interior surface 55 of the inlet header 40 downwardly toward the fiber bundle 20. In the preferred embodiment illustrated, the vanes 58 are curved. The curved vanes 58 impart a circular or swirling motion to the blood as it transitions from an axial flow in the inlet channel 42 to a radial flow along the top interior 55 header surface. This allows the blood to remain in motion preventing stagnant zones to form in the perimeter region, as can be observed in standard dialyzers.

It should be noted that various modifications are possible to the header 40. For example, by varying the header roof height “H” changes in fluid flow can be achieved. Further, in the preferred embodiment illustrated the outlet opening includes a large radius “R” to minimize the sudden expansion of fluid from the inlet channel 42 which can cause recirculation zones in that area.

In the preferred embodiment illustrated, the header 40 includes eight vanes 58. If desired, more or less vanes 52 can be utilized. However, it is believed that eight may be a preferable number. More than eight vanes 58 can increase flow resistance to the blood. Less than eight vanes can create reduced blood flow velocity between the vanes 58. In this regard, it is desired that the blood, as it enters the inlet header, follows the vanes 58 and not take a straight line path to the wall of lip 44. The design of the header 40 prevents blood from entering the header and running radially outward impinging on the outer wall of the lip 44. This prevents stagnant zones obtaining better distribution of blood on the fibers.

Referring now to FIG. 3, a further embodiment of the inlet header design is illustrated. The inlet header 70 includes a similar body structure to the previous header design including an inlet channel 72, body member 74, and lip 76. Further, the header design includes a plurality of members 78 for modifying the fluid flow of blood as it enters the inlet header.

With respect to the inlet header design of FIG. 2, it was observed that two mechanisms exist which tend to reduce the flow velocity as blood moves from the inlet channel to the outer perimeter. First, as the blood enters the dialyzer it begins to flow into the hollow fibers 20. This reduces the mass flow rate of the remaining blood as it approaches the perimeter. Second, the space between the vanes widens with distance from the inlet opening. This creates a larger cross-sectional area through which blood must flow. Since blood velocity equals the mass flow rate divided by the cross-sectional area, an increase in channel size will reduce the blood velocity.

To reduce velocity loss, in the embodiment illustrated in FIG. 3, raised channels 80 are provided. The raised channels 80 have a decreasing cross-sectional area to help alleviate the velocity loss. Additionally, the space between the channels 80 is lowered to just above the cut surface. This provides a higher resistance to flow in this area thereby allowing the blood to flow through the curved channels 80 toward the perimeter with a swirling action.

In the inlet header 70, any number of raised channels 80 can be utilized. However, preferably the inlet header 70 includes eight channels 80.

Referring now to FIG. 4, a further embodiment of the inlet header 84 is illustrated. In this embodiment, the inlet header includes a plurality of members 86 that are designed to modify the flow of blood as it enters the inlet header 84. Preferably these members are curved vane members 86. However, in addition, a flat disk 88 is incorporated at the bottom of the vane surfaces. The disk 88 functions to divert the inlet jet of blood from the inlet channel to the outer perimeter of the header. This thereby causes blood to flow under the disk 86 to the fiber surfaces.

In the inlet header 84, the combination of the disk 88 and vanes 86 assures a steady swirling flow of blood in the outer regions of the top of the fiber bundle. Thus, the blood is distributed to the perimeter of the bundle before the blood can begin to enter the fiber bundle. This ensures that blood will begin to flow into the outer fibers immediately upon entering the header.

It should be noted with respect to this design that it is also possible to use, instead of vanes 86, channels (such as the channels of FIG. 3). Once again, the number of vanes or channels can be modified although eight is preferred.

### EXAMPLE NO. 1

The following calculations illustrate the effect of dialysate shunts and blood and dialysate maldistributions on dialyzer clearance. Also, set forth below are estimates on the improvement in the clearance of existing dialyzers if the shunts and maldistributions could be eliminated.

The clearance (CL) of a counterflow dialyzer is give by the following equations:

CL=Qb{1−exp[(KA/Qb)(1−Qb/Qd)]}/{Qb/Qd−exp[(KA/Qb)(1−Qb/Qd)]}

where

K=Overall mass transfer coefficient of the dialyzer for the solute of interest which consists of the mass transfer coefficients (the reciprocal of resistance) on the blood and dialysate sides of the membrane and that of the membrane itself, min/cm

A=Area dialyzer, sq.cm.

Qb=Blood flow rate, ml/min.

Qd=Dialysate flow rate, ml/min

If Qb=Qd

CL=Qb(KA/Qb)/[(KA/Qb)+1]

These equations can be used to calculate the three mass transfer resistances of the standard dialyzers from measured urea clearances. The blood side resistance is 7.6 min/cm, the membrane resistance is 4.6 min/cm, and the dialysate side resistance is 6.4 min/cm.

These equations can also be used to calculate the clearance of a dialyzer to illustrate the effect of shunts and maldistributions of the flows.

Effect of a Dialysate Shunt

If a portion of the dialysate flow does not pass through the fiber bundle of a hollow fiber dialyzer, but shunts between the bundle and the case, the clearance of the dialyzer will be reduced. For analysis purposes it is assumed that the dialysate flow rate in the above equations is reduced by the amount of the shunt.

Tables 1 and 2 show the reduction in urea clearance with dialysate shunts for a 2.0 square meter and a 2.4 square meter dialyzer. The overall mass transfer coefficient has been adjusted downward to account for the lower dialysate side mass transfer coefficient due to the reduced effective dialysate flow caused by the shunt. It can be seen from these two tables that a large dialysate shunt can dramatically reduce the clearance of a dialyzer. Urea clearance as a function of percentage dialysate shunt for a 2.0 square meter dialyzer with 300 ml/min blood flow and 500 ml/min dialysate flow, is reduced from 269 ml/min to 229 ml/min by a 40% dialysate shunt. For a 2.4 square meter dialyzer, the clearance drops from 278 ml/min to 238 ml/min due to a 40% shunt.

This analysis can also be used to predict the increase in clearance of a dialyzer if a shunt of known magnitude is eliminated. From a measured or calculated clearance value and an assumed shunt magnitude, the overall mass transfer coefficient of the dialyzer can be determined from the preceding equations. Using this calculated value of K and assuming the elimination of the assumed shunt, improved clearance can be calculated. Table 3 shows the predicted urea clearances of 1.3, 1.6, 1.8 and 2.0 square meter dialyzers where 0%, 10%, 15% and 20% shunt have been eliminated for a blood flow of 300 ml/min and dialysate flow rate of 500 ml/min.

Effect of Blood and Dialysate Maldistribution.

If the distribution of blood flow through the fibers is not uniform and/or the distribution of dialysate flow through the fiber bundle is not uniform, the clearance of the dialyzer can suffer. Table 4 sets forth the results of four different maldistributions in a 2.0 square meter dialyzer.

In Table 4, Line 1 provides the urea clearance of a dialyzer without maladistributions. Line 2 provides the urea clearance of a dialyzer with blood flow 10% higher. Line 3 is the urea clearance with 10% lower blood flow. In a dialyzer where half the fibers have 10% higher blood flow and the other half have 10% lower blood flow, the clearance of this dialyzer will be the average of the clearances on lines 2 and 3 which is shown on line 4. For a 10% maladistribution of blood flow over the two halves of the dialyzer the urea clearance is only reduced from 268.8 to 267.6 ml/min., a minor reduction.

Lines 5, 6 and 7 of Table 4 set forth a 10% variation in dialysate flow that was added to the 10% blood flow variation with the higher blood flow occurring where the dialysate flow is lower (as what might occur near the center of the bundle). Here the urea clearance dropped further to 265.8 ml/min.

On lines 9 and 10, the dialysate maladistribution is increased to 20%. The urea clearance drops still further to 262.8 ml/min.

On line 11, 12 and 13, 10% variations of blood and dialysate are again considered but, here the maximum blood flow rate occurs where the maximum dialysate flow occurs (as what might happen at the outer portions of the fiber bundle in a dialyzer with a tangential blood inlet header). Here the urea clearance is 268.3 ml/min, almost the same as a dialyzer without any maldistribution.

Using calculations similar to those of Table 4, a 20% maldistribution of both the blood and dialysate will result in a 12 ml/min reduction in clearance reduction in dialyzer clearance for a 2.0 square meter dialyzer at 300 ml/min blood flow and 500 ml/min dialysate flow that can be expected when flow maldistributions of either the blood or dialysate are corrected.

Table 5 provides results similar to Table 4 for a 2.4 square meter dialyzer with a 10% blood maldistribution. Here it is seen that a 20% dialysate shunt reduces the clearance from 276.5 ml/min (line 4) to 271.3 ml/min (line 10).

Table 6 provides similar results for 500 ml/min blood flow and 800 ml/min dialysate flow. Here a 20% dialysate maldistribution results in a clearance reduction from 9.6 ml/min (line 4) to 402.7 ml/min (line 10).

Conclusions

The preceding calculations illustrate that a dialysate shunt can significantly reduce the clearance of a dialyzer. Elimination of dialysate shunts will significantly increase the clearance of a dialyzer.

These calculations also demonstrate that blood and dialysate flow maldistributions can reduce dialyzer clearance significantly. Elimination of flow maldistributions on either the blood side or dialysate side of a dialyzer will improve clearance values.

TABLE 1
Clearance with Dialysate Shunts

| Line | Qb(ml/min) | Qd(ml/min) | Z = Qb/Qd | K(min/cm) | A(cm**2) | Nt = KA/Qb | CL(ml/min) |
|---|---|---|---|---|---|---|---|
| | Qb = 200 | | | | | | |
| 1 | 200 | 500 | 0.400 | 0.056 | 20000 | 5.600 | 195.773 |
| 2 | 200 | 450 | 0.444 | 0.054 | 20000 | 5.400 | 194.343 |
| 3 | 200 | 400 | 0.500 | 0.052 | 20000 | 5.200 | 192.286 |
| 4 | 200 | 350 | 0.571 | 0.05 | 20000 | 5.000 | 189.221 |
| 5 | 200 | 300 | 0.667 | 0.048 | 20000 | 4.800 | 184.447 |
| 6 | 200 | 250 | 0.800 | 0.046 | 20000 | 4.600 | 176.598 |
| | Qb = 300 | | | | | | |
| 7 | 300 | 500 | 0.600 | 0.056 | 20000 | 3.733 | 268.847 |
| 8 | 300 | 450 | 0.667 | 0.054 | 20000 | 3.600 | 262.313 |
| 9 | 300 | 400 | 0.750 | 0.052 | 20000 | 3.467 | 253.959 |
| 10 | 300 | 350 | 0.857 | 0.05 | 20000 | 3.333 | 243.069 |
| 11 | 300 | 300 | 1.000 | 0.048 | 20000 | 3.200 | 228.571 |
| | Qb = 400 | | | | | | |
| 12 | 400 | 500 | 0.800 | 0.056 | 20000 | 2.800 | 315.849 |
| 13 | 400 | 450 | 0.889 | 0.054 | 20000 | 2.700 | 303.585 |
| 14 | 400 | 400 | 1.000 | 0.052 | 20000 | 2.600 | 288.889 |
| 15 | 400 | 350 | 1.143 | 0.05 | 20000 | 2.500 | 271.063 |
| 16 | 400 | 300 | 1.333 | 0.048 | 20000 | 2.400 | 249.171 |
| | Qb = 500 | | | | | | |
| 17 | 500 | 500 | 1.000 | 0.056 | 20000 | 2.240 | 345.679 |
| 18 | 500 | 450 | 1.111 | 0.054 | 20000 | 2.160 | 328.788 |
| 19 | 500 | 400 | 1.250 | 0.052 | 20000 | 2.080 | 309.300 |
| 20 | 500 | 350 | 1.429 | 0.05 | 20000 | 2.000 | 286.610 |

TABLE 2
Clearance with Dialysate Shunts

| Line | Qb(ml/min) | Qd(ml/min) | Z = Qb/Qd | K(min/cm) | A(cm**2) | Nt = KA/Qb | CL(ml/min) |
|---|---|---|---|---|---|---|---|
| | Qb = 200 | | | | | | |
| 1 | 200 | 500 | 0.400 | 0.056 | 24000 | 6.720 | 197.856 |
| 2 | 200 | 450 | 0.444 | 0.054 | 24000 | 6.480 | 196.927 |
| 3 | 200 | 400 | 0.500 | 0.052 | 24000 | 6.240 | 195.485 |
| 4 | 200 | 350 | 0.571 | 0.05 | 24000 | 6.000 | 193.150 |
| 5 | 200 | 300 | 0.667 | 0.048 | 24000 | 5.760 | 189.167 |
| 6 | 200 | 250 | 0.800 | 0.046 | 24000 | 5.520 | 181.951 |
| | Qb = 300 | | | | | | |
| 7 | 300 | 500 | 0.600 | 0.056 | 24000 | 4.480 | 277.784 |
| 8 | 300 | 450 | 0.667 | 0.054 | 24000 | 4.320 | 271.863 |
| 9 | 300 | 400 | 0.750 | 0.052 | 24000 | 4.160 | 263.929 |
| 10 | 300 | 350 | 0.857 | 0.05 | 24000 | 4.000 | 253.092 |
| 11 | 300 | 300 | 1.000 | 0.048 | 24000 | 3.840 | 238.017 |
| | Qb = 400 | | | | | | |
| 12 | 400 | 500 | 0.800 | 0.056 | 24000 | 3.360 | 330.924 |
| 13 | 400 | 450 | 0.889 | 0.054 | 24000 | 3.240 | 318.367 |
| 14 | 400 | 400 | 1.000 | 0.052 | 24000 | 3.120 | 302.913 |
| 15 | 400 | 350 | 1.143 | 0.05 | 24000 | 3.000 | 283.718 |
| 16 | 400 | 300 | 1.333 | 0.048 | 24000 | 2.880 | 259.714 |
| | Qb = 500 | | | | | | |
| 17 | 500 | 800 | 0.625 | 0.056 | 24000 | 2.688 | 411.352 |
| 18 | 500 | 720 | 0.694 | 0.054 | 24000 | 2.592 | 399.048 |
| 19 | 500 | 640 | 0.781 | 0.052 | 24000 | 2.496 | 384.270 |
| 20 | 500 | 560 | 0.893 | 0.05 | 24000 | 2.400 | 366.196 |

TABLE 3
INCREASE IN CLEARANCE WITH ELIMINATION OF 10%, 15%
AND 20% DIALYSATE SHUNT

| Qb | Qd | Kurea | A | Nt | Z | CLurea | Shunt |
|---|---|---|---|---|---|---|---|
| 300 | 500 | 0.054 | 13000 | 2.329 | 0.6 | 238.104 | 0% |
| 300 | 500 | 0.057 | 13000 | 2.472 | 0.6 | 242.527 | 10% |
| 300 | 500 | 0.059 | 13000 | 2.569 | 0.6 | 245.322 | 15% |
| 300 | 500 | 0.062 | 13000 | 2.691 | 0.6 | 248.592 | 20% |
| 300 | 500 | 0.054 | 16000 | 2.867 | 0.6 | 252.898 | 0% |
| 300 | 500 | 0.058 | 16000 | 3.083 | 0.6 | 257.625 | 10% |
| 300 | 500 | 0.061 | 16000 | 3.227 | 0.6 | 260.465 | 15% |
| 300 | 500 | 0.064 | 16000 | 3.410 | 0.6 | 263.773 | 20% |
| 300 | 500 | 0.054 | 18000 | 3.225 | 0.6 | 260.432 | 0% |
| 300 | 500 | 0.058 | 18000 | 3.458 | 0.6 | 264.578 | 10% |
| 300 | 500 | 0.061 | 18000 | 3.634 | 0.6 | 267.375 | 15% |
| 300 | 500 | 0.064 | 18000 | 3.860 | 0.6 | 270.616 | 20% |
| 300 | 500 | 0.054 | 20000 | 3.583 | 0.6 | 266.598 | 0% |
| 300 | 500 | 0.059 | 20000 | 3.923 | 0.6 | 271.442 | 10% |
| 300 | 500 | 0.062 | 20000 | 4.140 | 0.6 | 274.134 | 15% |
| 300 | 500 | 0.066 | 20000 | 4.425 | 0.6 | 277.230 | 20% |

TABLE 4
ANALYSIS OF BLOOD AND DIALYSATE FLOW DISTRIBUTION VARIATIONS

| | | | | | | | |
|---|---|---|---|---|---|---|---|
| Line | Qb(ml/min) | Qd(ml/min) | Z = Qb/Qd | K(min/cm) | A(cm**2) | Nt = KA/Qb | CL(ml/min) |

10% Qb variation, Qd uniform

| | | | | | | | |
|---|---|---|---|---|---|---|---|
| 1 | 300 | 500 | 0.600 | 0.056 | 20000 | 3.733 | 268.847 |
| 2 | 330 | 500 | 0.660 | 0.056 | 20000 | 3.394 | 285.311 |
| 3 | 270 | 500 | 0.540 | 0.056 | 20000 | 4.148 | 249.970 |

| | |
|---|---|
| 4 | AVERAGE 267.640 |

10% Qb variation, 10% Qd variation, Qb max where Qd min.

| | | | | | | | |
|---|---|---|---|---|---|---|---|
| 5 | 330 | 450 | 0.733 | 0.056 | 20000 | 3.394 | 279.388 |
| 6 | 270 | 550 | 0.491 | 0.056 | 20000 | 4.148 | 252.314 |

| | |
|---|---|
| 7 | AVERAGE 265.851 |

10% Qb variation, 20% Qd variation, Qb max where Qd min.

| | | | | | | | |
|---|---|---|---|---|---|---|---|
| 8 | 330 | 400 | 0.825 | 0.056 | 20000 | 3.394 | 271.436 |
| 9 | 270 | 600 | 0.450 | 0.056 | 20000 | 4.148 | 254.103 |

| | |
|---|---|
| 10 | AVERAGE 262.770 |

10% Qb variation, 10% Qd variation, Qb max. where Qd max.

| | | | | | | | |
|---|---|---|---|---|---|---|---|
| 11 | 300 | 500 | 0.600 | 0.056 | 20000 | 3.733 | 268.847 |
| 12 | 330 | 550 | 0.600 | 0.056 | 20000 | 3.394 | 289.839 |
| 13 | 270 | 450 | 0.600 | 0.056 | 20000 | 4.148 | 246.801 |

| | |
|---|---|
| 14 | AVERAGE 268.320 |

TABLE 5
ANALYSIS OF BLOOD AND DIALYSATE FLOW DISTRIBUTION VARIATIONS

| | | | | | | | |
|---|---|---|---|---|---|---|---|
| Line | Qb(ml/min) | Qd(ml/min) | Z = Qb/Qd | K(min/cm) | A(cm**2) | Nt = KA/Qb | CL(ml/min) |

10% Qb variation, Qd uniform

| | | | | | | | |
|---|---|---|---|---|---|---|---|
| 1 | 300 | 500 | 0.600 | 0.056 | 24000 | 4.480 | 277.784 |
| 2 | 330 | 500 | 0.660 | 0.056 | 24000 | 4.073 | 296.344 |
| 3 | 270 | 500 | 0.540 | 0.056 | 24000 | 4.978 | 256.692 |

| | |
|---|---|
| 4 | AVERAGE 276.518 |

10% Qb variation, 10% Qd variation, Qb max where Qd min.

| | | | | | | | |
|---|---|---|---|---|---|---|---|
| 5 | 330 | 450 | 0.733 | 0.056 | 24000 | 4.073 | 290.525 |
| 6 | 270 | 550 | 0.491 | 0.056 | 24000 | 4.978 | 258.654 |

| | |
|---|---|
| 7 | AVERAGE 274.589 |

10% Qb variation, 20% Qd variation, Qb max where Qd min.

| | | | | | | | |
|---|---|---|---|---|---|---|---|
| 8 | 330 | 400 | 0.825 | 0.056 | 24000 | 4.073 | 282.451 |
| 9 | 270 | 600 | 0.450 | 0.056 | 24000 | 4.978 | 260.102 |

| | |
|---|---|
| 10 | AVERAGE 271.277 |

10% Qb variation, 10% Qd variation, Qb max. where Qd max.

| | | | | | | | |
|---|---|---|---|---|---|---|---|
| 11 | 300 | 500 | 0.600 | 0.056 | 24000 | 4.480 | 277.784 |
| 12 | 330 | 550 | 0.600 | 0.056 | 24000 | 4.073 | 300.662 |
| 13 | 270 | 450 | 0.600 | 0.056 | 24000 | 4.978 | 253.937 |

| | |
|---|---|
| 14 | AVERAGE 277.300 |

TABLE 6
ANALYSIS OF BLOOD AND DIALYSATE FLOW DISTRIBUTION VARIATIONS

| | | | | | | | |
|---|---|---|---|---|---|---|---|
| Line | Qb(ml/min) | Qd(ml/min) | Z = Qb/Qd | K(min/cm) | A(cm**2) | Nt = KA/Qb | CL(ml/min) |

10% Qb variation, Qd uniform

| | | | | | | | |
|---|---|---|---|---|---|---|---|
| 1 | 500 | 800 | 0.625 | 0.056 | 24000 | 2.688 | 411.352 |
| 2 | 550 | 800 | 0.688 | 0.056 | 24000 | 2.444 | 432.162 |
| 3 | 450 | 800 | 0.563 | 0.056 | 24000 | 2.987 | 387.128 |

| | |
|---|---|
| 4 | AVERAGE 409.645 |

10% Qb variation, 10% Qd variation, Qb max where Qd min.

| | | | | | | | |
|---|---|---|---|---|---|---|---|
| 5 | 550 | 720 | 0.764 | 0.056 | 24000 | 2.444 | 422.278 |
| 6 | 450 | 880 | 0.511 | 0.056 | 24000 | 2.987 | 392.013 |

| | |
|---|---|
| 7 | AVERAGE 407.145 |

10% Qb variation, 20% Qd variation, Qb max where Qd min.

| | | | | | | | |
|---|---|---|---|---|---|---|---|
| 8 | 550 | 640 | 0.859 | 0.056 | 24000 | 2.444 | 409.551 |
| 9 | 450 | 960 | 0.469 | 0.056 | 24000 | 2.987 | 395.897 |

| | |
|---|---|
| 10 | AVERAGE 402.724 |

10% Qb variation, 10% Qd variation, Qb max. where Qd max.

| | | | | | | | |
|---|---|---|---|---|---|---|---|
| 11 | 500 | 800 | 0.625 | 0.056 | 24000 | 2.688 | 411.352 |
| 12 | 550 | 880 | 0.625 | 0.056 | 24000 | 2.444 | 440.011 |
| 13 | 450 | 720 | 0.625 | 0.056 | 24000 | 2.987 | 380.836 |

| | |
|---|---|
| 14 | AVERAGE 410.423 |

### EXAMPLE NO. 2

A computational fluid dynamics (CFD) analysis was performed for the blood dialysate flow transport phenomena occurring in dialyzers of various designs. This experiment assumed that there is no mass-transfer (ultra-filtration) between the blood and the dialysate flows through the porous fiber wall. The two flow fields were analyzed separately. Several different housing variations and header designs were considered. A porous medium model was used to simulate the flow in the fiber bundle. The flow permeability for the fiber-bundle was computed from a CFD model.

This study concluded that in general the blood flow distributions in the fiber-bundle are fairly uniform. But a flow stagnant region usually exists in the inlet header. A flattened header design can greatly reduce the flow stagnant region.

The dialysate flow distributions are quite non-uniform for the regions adjacent to the flow inlet and outlet. However, the distributions of dialysate flow for the dialyzer header designs of the present invention are more uniform than the conventional dialyzer.

There are thousands of fibers in a dialyzer. It is not feasible to solve for the detailed flow distribution around each fiber. A porous medium model is used here for modeling the over-all flow and pressure distributions in the fiber-bundle. The model assumes that there is a local balance between pressure and resistance forces in the flow domain such that:

−KᵢUᵢ=∂p/∂ξᵢ,

where (i=1,2,3) represents the orthotropic directions (three mutually orthogonal principal axes with differening material properties or conditions). Kᵢ is the permeability and Uᵢ is the superficial velocity in direction ξᵢ. (The volume flow rate divided by the total cross-sectional area.) The permeability Kᵢ is computed by the following equation:

Kᵢ=αᵢ|Û|+βᵢ

where αᵢ and βᵢ are constants for a particular flow, Û is the superficial velocity vector. It is noted that the permeability in Darcy's law is defined as:

−μUᵢ=κᵢ∂p/∂ξ_{I}

where Kᵢ is the permeability and is equal to μ/Kᵢ.

The flow in the dialyzer is assumed to be laminar, steady state, incompressible, and Newtonian. The permeability for the porous-medium flow model should be derived from the flow pressure drop in the fiber-bundle measured experimentally. However, the experimental data are not available. The other alternative is to solve for the pressure distributions numerically. First it is assumed that the fibers are arranged in a fixed staggered pattern. The space in between the fibers is computed from the given fiber packing factor.

The blood flow in a dialyzer is inside the hollow fibers. The porous medium flow permeability along the axial-direction is computed based on the pressure drop for a fully developed laminar pipe flow. The permeability is infinite for cross flow.

For the dialysate flow outside the fibers, the pressure drop is computed numerically for flow in several layers of fibers. Then the flow permeability is calculated from the computed pressure gradient for the particular fiber configuration. The axial flow pressure drop is different from the cross-flow pressure drop and the flow in each direction is computed separately.

It is noted that the porous medium model is only an approximation for the actual complicated flow problem. The fiber distributions in a dialyzer are usually non-uniform and the flow permeability varies spatially.

There are 14,000-15,000 fibers in the dialyzer. The fiber ID and OD are 190 μm and 230 μm, respectively. The fiber-bundle OD is 3.45 cm. The present analysis assumes that the number of fibers is 14,000, giving a total fiber surface area of 2.3 m². The blood flow porosity (void fraction) is 0.425 and, from the fully developed pipe flow theory, the flow permeability is 8.348×10⁶ kg/m³s.

It was found that flow pressure decreases gradually from the flow inlet to the outlet with a total pressure drop of 128 mmHg. The blood flow velocity is high near the center of the dialyzer, while away from the axis the flow velocity magnitude diminishes. The inlet jet creates a large recirculation region in the center of the header. The flow converges smoothly from the header to the outlet pipe and no flow recirculation is observed.

By using a simplified over-all mass transfer equation had computed the effects of blood flow variation on the blood clearance. Example No. 1 found that at the flow rates of 300 and 500 ml/min, for blood and dialysate, respectively, a variation of 2.5% blood flow rate would result in an approximately +/−1.8% variation in blood clearance. The clearance is defined as the mass transfer rate divided by the concentration gradient prevailing at the inlet of the dialyzer.

High flow shear rates are generated from the inlet pipe flow and the jet impinging on the fiber cut-surface. The maximum shear rate in the header is 1185 1/s. For the flow in the fiber bundle the maximum shear rate is computed from the wall shear rate for a filly developed pipe flow theory. It has been observed (Reference 4) that sublethal damage to red blood cells can occur at turbulent shear stress levels of 500 dynes/cm². This corresponds to a shear rate level of 12,500 1/s for blood flow. Therefore the damage to red blood cell is not predicted to occur for this dialyzer.

Header Dialyzer with 8 Vanes

At least in part, the purpose of the vanes in this header design is to create swirling flow for the reduction of potential stagnant flow region located at the outer perimeter on the dialyzer.

There are 9,800 fibers in the dialyzer. For blood flow the fiber packing-factor is 0.538. The fiber ID and OD are 200 μm and 260 μm, respectively. The fiber length is 31.55 cm and the fiber surface area is 1.94 m². The computed porous medium flow permeability is 1×10⁷ kg/m³s for axial flow and infinite for cross-flow.

Three different gap sizes between the lower vane surface and the fiber cut surface were analyzed. They are:

Case 1: Maximum gap of 0.050″

Case 2: Nominal gap of 0.025″

Case 3: Minimum gap of 0.002″

For each case two different blood flow rates of 200 and 500 ml/min were analyzed.

Velocity vectors follow the shape of the vanes and result in spiral patterns. Most of the flow is moving toward the center of the housing due to the recirculating flow described in the previous section. The peak flow velocity is located adjacent to the center of the plane due to the inlet port flow. But at the outer perimeter of the housing there is still a flow stagnant region.

In general the flow velocity is very uniform inside the fiber-bundle. For all three cases the maximum flow velocity variation inside the fiber bundle is less than 4.3%. It was seen that the flow stagnant region reduces with an increase of the gap size.

Flattened Header with 8 Vanes

The gap between the vanes bottom surface and the fiber-potting surface is 0.05″.

Flattened Turbo Header without Vanes

For comparison purposes we also analyzed the flattened header without vanes. The surface area of the dialyzer is 1.94 m². The dialysate flow velocity was found not to be very uniform adjacent to the flow inlet and outlet and there is a 50% difference between the maximum and the minimum values. The velocity profiles are more uniform in the mid-section of the bundle, with about a 2% difference between the maximum and minimum values.

For this dialyzer design, the fiber packing density is 0.537 in the straight bundle section. The packing density in the bell is reduced to a value of 0.306. The value for the permeability in the transition region is assumed to vary linearly from the straight bundle section to the bell region.

Conclusions

The study concluded that, for the dialyzers analyzed, the blood flow distribution in the dialyzer is usually fairly uniform. For the dialysate flow, however, the flow distribution seems to be less uniform. This is especially true for the flow adjacent to the dialysate inlet and outlet.

For a dialyzer with an axial inlet a flow recirculation zone is usually observed in the blood inlet header. This zone could be reduced significantly by flattening the inlet header housing wall.

The predicted blood flow shear rates in the headers for all dialyzers analyzed in this study are significantly lower than the published values which can cause sublethal damage to red blood cells.

The dialyzers of the present invention do make the dialysate flow more uniform than the conventional designs. The present study showed that a flattened header could significantly reduce the flow stagnant region.

Furthermore the dialysate flow distribution is very uniform for the cases with Q_{d}=500 and 1000 ml/min. The flow patterns are very similar between the two cases and the velocity magnitude is directly proportional to Q_{d}.

TABLE 1A
Input parameters for various runs (blood side)

| | Prior Art | | Dialyzer with |
|---|---|---|---|
| Run Name | Dialyzer | | radial inlet |
| Fiber parameters | | | |
| ID (μm) | 190 | | 190 |
| OD (μm) | 230 | | 230 |
| Wall thickness (μm) | 20 | | 20 |
| Number of fibers | 14,000 | | 14,000 |
| Effective fiber length (cm) | 27.64 | | 27.64 |
| Dialyzer surface area (m²) | 2.3 | | 2.3 |
| Fiber packing factor | | | |
| Straight section | 0.62 | | 0.62 |
| Bell | 0.62 | | 0.62 |
| Blood header parameters | | | |
| Type | Axial inlet | | Radial inlet |
| Maximum internal diameter | 3.97 | | 3.97 |
| (cm) | | | |
| Number of vanes | 0 | | 0 |
| Gap between bottom of vanes | — | | — |
| & urethane cut surface | | | |
| Q_{b} (ml/min) | 400 | 200 | 400 |

| Axial porosity | 0.38 | | | 0.38 |
|---|---|---|---|---|
| Blood viscosity (cp) | 4 | | | 4 |
| Blood density (kg/m³) | 1060 | | | 1060 |
| Blood temperature (° C.) | 38 | | | 38 |
| Permeability | | | | |
| Parallel flow (kg/m³s) | 8.348 × 10⁶ | | | 8.348 × 10⁶ |
| Cross flow (kg/m³s) | Infinite | | | Infinite |
| | Turbo header | | | Flattened turbo |
| | dialyzer with 8 | | | header without |
| Run Name | vanes | | | vanes |
| Fiber parameters | | | | |
| ID (μm) | 200 | | | 200 |
| OD (μm) | 260 | | | 260 |
| Wall thickness (μm) | 30 | | | 30 |
| Number of fibers | 9,800 | | | 9,800 |
| Effective fiber length (cm) | 31.55 | | | 31.55 |
| Dialyzer surface area (m²) | 1.94 | | | 1.94 |
| Fiber packing factor | | | | |
| Straight section | 0.538 | | | 0.538 |
| Bell | 0.538 | | | 0.538 |
| Blood header parameters | | | | |
| Type | Axial inlet | | | Axial inlet |
| Maximum internal diameter | 5.944 | | | 5.486 |
| (cm) | | | | |
| Number of vanes | 8 | | | 0 |
| Gap between bottom of vanes | 0.05 | 0.02 | 0.00 | — |
| & urethane cut surface (inches) | 0 | 5 | 2 | |
| Blood parameters | | | | |

| | | | |
|---|---|---|---|
| Q_{b} (ml/min) | 200 | 500 | 500 |

| | | |
|---|---|---|
| Axial porosity | 0.38 | 0.38 |
| Blood viscosity (cp) | 4 | 4 |
| Blood density (kg/m³) | 1060 | 1060 |
| Blood temperature (° C.) | 38 | 38 |
| Permeability | | |
| Parallel flow (kg/m³s) | 1 × 10⁷ | 1 × 10⁷ |
| Cross flow (kg/m³s) | Infinite | Infinite |

TABLE 1B
Output values for the various runs (blood side)

| | | |
|---|---|---|
| | | Dialyzer |
| | | with radial |
| Run Name | Prior Art Dialyzer | inlet |

| | | | |
|---|---|---|---|
| Q_{b} (ml/min) | 400 | 200 | 400 |
| Blood side - Fiber bundle | | | |
| Figures of results | 6 | 8-9 | 14 |
| Pressure drop (mmHg) | 121.5 | 60.6 | 123.8 |
| Maximum shear rate | 868.9 | 434.4 | 868.9 |
| Maximum % flow | 2.5 | 1.4 | 0.3 |
| maldistribution | | | |
| Blood side - header | | | |
| Figures of results | 3-5, 7 | | 13, 15 |
| Pressure drop (mHg) | 6.1 | 2.4 | 4.5 |
| Maximum shear rate (l/s) | 1185 | 601.8 | 2500 |
| Location of maximum | Intersection | Intersection | Inlet port |
| shear | of fiber cut | of fiber cut | |
| | surface and | surface and | |
| | inlet jet | inlet jet | |
| Extent of stagnant & | large | large | Small |
| recirculating zones | | | |

| | Turbo header dialyzer | | Flattened turbo header | |
|---|---|---|---|---|
| Run Name | with 8 vanes | | dialyzer with 8 vanes | |
| Q_{b} (ml/min) | 200 | 500 | 200 | 500 |
| Blood side - Fiber bundle | | | | |
| Figures of results | | 23 | 24 | 24, 28 |
| Pressure drop (mmHg) | 60.6 | 121.5 | 42.4 | 110.4 |
| Maximum shear rate | 433.2 | 1083 | 433.2 | 1083 |
| Maximum % flow | 1.4 | 2.5 | | |
| maldistribution | | | | |
| Blood side - header | | | | |
| Figures of results | 17-20, 22 | 17-20, 22 | | 25-27 |
| Pressure drop (mHg) | 2.4 | 6.1 | 2.7 | 4.6 |
| Maximum shear rate (l/s) | 256.8 | 506.6 | 657.5 | 1547 |
| Location of maximum | Intersec- | Intersec- | Inlet port | Inlet port |
| shear | tion of fi- | tion of fi- | | |
| | ber cut | ber cut | | |
| | surface | surface | | |
| | and inlet | and inlet | | |
| | jet | jet | | |
| Extent of stagnant & | large | large | small | small |
| recirculating zones | | | | |

| | Flattened Turbo header |
|---|---|
| Run Name | dialyzer without vanes |
| Q_{b} (ml/min) | 500 |
| Blood side - Fiber bundle | |
| Figures of results | |
| Pressure drop (mmHg) | 4.0 |
| Maximum shear rate (l/s) | 1083 |
| Maximum % flow | |
| maldistribution | |
| Blood side - header | |
| Figures of results | 29-31 |
| Pressure drop (mHg) | 110.8 |
| Maximum shear rate (l/s) | 1490 |
| Location of maximum shear | Inlet port |
| Extent of stagnant & | Small |
| recirculating zones | |

It should be understood that various changes and modifications to the presently preferred embodiments described herein will be apparent to those skilled in the art. Such changes and modifications can be made without departing from the spirit and scope of the present invention and without diminishing its intended advantages. It is therefore intended that such changes and modifications be covered by the appended claims.

1. A dialyzer inlet header comprising:
a body that is designed to be attached to an end of a dialyzer;
an inlet channel providing fluid communication from an exterior of the dialyzer to an interior of the dialyzer, the inlet channel defining a fluid flow path that is axial to a fiber bundle located in the interior of the dialyzer; and
at least one member for modifying the fluid flow path of a fluid as it exits the inlet channel.

2. The dialyzer inlet header of claim 1 wherein the member for modifying the fluid flow path is a curved vane extending from a portion of the body.

3. The dialyzer inlet header of claim 2 including eight vanes.

4. The dialyzer inlet header of claim 1 wherein the inlet channel is located at a center of the body.

5. The dialyzer inlet header of claim 1 wherein the header is sealed to an end of a dialyzer casing.

6. The dialyzer inlet header of claim 1 wherein the member for modifying the fluid flow path is a curved channel extending into a portion of the body.

7. The dialyzer inlet header of claim 6 including eight channels extending into the body.

8. The dialyzer inlet header of claim 1 wherein the member for modifying the fluid flow path obstructs the flow of fluid as it exits the fluid channel.

9. The dialyzer inlet header of claim 8 wherein the member for modifying the fluid flow path is a disk located under an exit opening of the inlet fluid channel.

10. The dialyzer inlet header of claim 9 wherein the body includes a plurality of curved vanes.

11. The dialyzer inlet header of claim 9 wherein the body includes a plurality of curved channels.

12. A dialyzer comprising:
a body defining an interior and having a first end and a second end;
a fiber bundle located in the interior;
a blood inlet located at the first end and including a fluid flow channel that causes the blood to flow in an axial direction with respect to the fiber bundle; and
a member located in juxtaposition to the blood inlet that causes blood to flow to a perimeter region of a first end of the fiber bundle.

13. The dialyzer of claim 12 wherein the member is a curved vane extending from a portion of the body.

14. The dialyzer of claim 12 wherein inlet channel is located at a center of the body.

15. The dialyzer of claim 12 wherein the header is sealed to an end of the dialyzer body.

16. The dialyzer of claim 12 wherein the member is a curved channel extending into a portion of the body.

17. The dialyzer of claim 12 wherein the member is a disk located under an exit opening of the inlet fluid channel.

18. The dialyzer inlet header of claim 17 wherein a plurality of curved vanes.

19. The dialyzer of claim 17 wherein the member includes a plurality of curved channels.

20. The dialyzer of claim 12 including a dialysate inlet and a dialysate outlet that define fluid flow channels that are radial to the fiber bundle.

21. A dialyzer header comprising a body member having an inlet channel providing fluid communication from an exterior to an interior of the header, the inlet channel defining a fluid path that is axial to a casing of a dialyzer to which the dialyzer head is attached and the body member including a plurality of members that impart a circular motion to the fluid as it enters the interior of the header.

22. The dialyzer header of claim 21 wherein the members are a plurality of curved vanes.

23. The dialyzer header of claim 20 wherein the members are a plurality of curved channels.

24. The dialyzer header of claim 21 wherein the members include a device that obstructs the flow of the fluid into portions of the interior of the header.

25. The dialyzer header of claim 24 wherein the device that obstructs is a disk located under the inlet channel.

26. The dialyzer inlet header of claim 21 wherein inlet channel is located at a center of the body.

27. The dialyzer inlet header of claim 21 including eight vanes.

28. The dialyzer inlet header of claim 21 including eight channels extending into the body member.

29. A method for providing dialysis comprising the steps of passing blood through a dialyzer that includes a blood inlet that defines an axial flow path with respect to a fiber bundle located in the dialyzer and modifying the flow path as the blood enters the dialyzer to increase the flow of blood to a perimeter of an end of the fiber bundle.

30. The method of claim 29 wherein the flow path is modified by passing at least some of the blood through channels.

31. The method of claim 29 wherein the flow path is modified by passing at least some of the blood through a flow path bounded by vanes.

32. The method of claim 29 wherein the flow path is modified by preventing the flow of the blood directly from the inlet to the fiber bundle.
